(19) United States
(12) Patent Application Publication
(10) Pub. No.: US 2006/0092327 A1
(43) Pub. Date: May 4, 2006

(54) Story segmentation method for video

(75) Inventors: Keiichiro Hoashi, Saitama (JP); Kazunori Matsumoto, Saitama (JP); Fumiaki Sugaya, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/261,792

(22) Filed: Oct. 31, 2005

(30) Foreign Application Priority Data
Nov. 2, 2004 (JP) 2004-319129

(51) Int. Cl. H04N 9/64; H04N 5/14

(52) U.S. Cl. 348/571

(57) ABSTRACT

In a shot segmentation process 11 and a section extraction process 12 in a training process, a training data is segmented into shot and specific sections are extracted. In a training process 14 for a story segmentation point recognizing device for entire video, a story segmentation point recognizing device for entire video is produced. In a training process 15 for a story segmentation point recognizing device for specific sections, story segmentation point recognizing device for specific sections is produced. In an evaluation process, the story segmentation points in entire input data and the story segmentation points in specific sections are recognized so that the story segmentation points of the input data are provided by integrating the both segmentation results.

### BACKGROUND OF THE INVENTION

1. Field of the Invention

The present invention relates to a story segmentation method for video. In particular, the present invention relates to a story segmentation method for video which can be applied to a system for presenting story segmentation point information in video content to a user.

2. Description of the Related Art

A method of supporting retrieval by presenting information on how a video content is segmented in story to a user in the case of retrieving a video is known. Japanese Patent Application Laid Open (JP-A) No. 5-342263 discloses a video data retrieval supporting method of processing sound data in video data into a text as character rows, extracting the segments having a common story continuously based on the character rows obtained thereby and identifying the nesting structure between the story in each segment and the segment so as to present the same to the user.

According to the video data retrieval supporting method of JP-A No. 5-342263, in the case the textual information is already added as in the case of the text broadcasting of the television, the process of converting sound data into character rows can be omitted, however, in the other cases, the process of converting sound data into character rows is necessary using a sound recognition device, key boards, or the like.

The non patent articles, S. Boykin et al: “Improving broadcast news segmentation processing”, Proceedings of IEEE Multimedia systems, pp. 744-749, 1999., Q. Huang et al: “Automated semantic structure reconstruction and representation generation for broadcast news”, SPIE Conf. on Storage and Retrieval for Image and Video Databases 7 Vol. 3656, pp. 50-62, 1999, and N. O'Connor et al: “News story segmentation in the Fischlar video indexing system”, Proc of ICIP 2001, pp. 418-421, 2001., propose a story segmentation method for video of news. According to the methods proposed by these non patent articles, based on the premise that a new anchor shot (shot with the main caster) is presented at the story changing point, anchor shot is extracted from the video so that the story segmentation point is set at the anchor shot appearance position.

On the other hand, in Japanese Patent application No. 2003-382817, the present inventor has proposed a story segmenting method based on a low level and commonly used feature such as color arrangements and movements in a shot without executing a high level video processing such as anchor shot retrievals.

However, according to the video data retrieval supporting method disclosed in JP-A No. 5-342263, the text information should be produced by processing the sound data in the video data before extracting the segments with continuing common story.

If the text information is originally present as in the case of the television textual broadcasting, the speech-to-text conversion process can be omitted; however, in the case the text information is not present as in the case of the video data of an ordinary television broadcast or the personal contents such as video recorded by a domestic video recorder, the speech-to-text conversion process is necessary as the preprocess of the segment extraction.

For the speech-to-text conversion process, the method of so-called “transcription” of producing a text manually by listening to the sound, the method of manually inputting an original manuscript of the sound data with the keyboards, the method of producing the text information by inputting the sound data into a speech recognition device, or the like can be used.

However, since the methods of “transcription” or inputting from the original manuscript by the worker are done by manpower so that much time and labor are required, and thus a problem is involved in that it cannot be used for video of an enormous amount. Moreover, the method of using a sound recognition device involves a problem in that the story segmentation accuracy in the latter stage is influenced by the recognition error generated depending on the accuracy of the speech recognition device used or the sound quality.

According to the methods disclosed in the non patent articles, S. Boykin et al: “Improving broadcast news segmentation processing”, Proceedings of IEEE Multimedia systems, pp. 744-749, 1999., Q. Huang et al: “Automated semantic structure reconstruction and representation generation for broadcast news”, SPIE Conf. on Storage and Retrieval for Image and Video Databases 7 Vol. 3656, pp. 50-62, 1999, and N. O'Connor et al: “News story segmentation in the Fischlar video indexing system”, Proc of ICIP 2001, pp. 418-421, 2001., even though the story segmentation points with the anchor shots provided as the starting points allow the high accuracy, a problem is involved in that the story segmentation points starting from a shot other than the anchor shot cannot be retrieved.

On the other hand, according to the method disclosed in the patent article 2, since the story is segmented based on the commonly used feature, the story segmentation can be enabled independently of the presence of the anchor shot. However, since the production of the story segmentation point recognizing device by training based on the entire video such as the news is the premise, a problem is involved in that the story segmentation accuracy is deteriorated as to a section with a different story configuration such as a sports section, or the like.

### SUMMARY OF THE INVENTION

An object of the present invention is to solve the above-mentioned problems and to provide a story segmentation method for video capable of extracting the story segmentation point in video contents without producing the text information, and capable of extracting the story segmentation point accurately and stably also for sections which have different story configurations.

In order to accomplish the object, the first feature of this invention is that a story segmentation method for video comprises a training process and an evaluation process, wherein video data with specified story segmentation points are provided to the training process as training data, the training process is for producing a story segmentation point recognizing device which conducts story segmentation for entire video content based on the training data, and a story segmentation point recognizing device specialized for story segmentation of specific sections in the video, and the evaluation process is to extract story segmentation points of input data by extracting story segmentation points from the entire video content in the video by using the story segmentation point recognition device generated based on the entire training data, and by extracting story segmentation point in specific sections in the video by using the section-specialized story segmentation point recognizing device, and integrating the former and latter story segmentation results.

Also, the second feature of this invention is that the story segmentation method for video, wherein the training process includes a first shot segmentation process for segmenting the training data per shot, a first section extraction process for extracting a section from the training data, a first feature extraction process for extracting features from each shot obtained by the first shot segmentation process, a training process for producing the story segmentation point recognizing device which conducts story segmentation for the entire video content based on the features of all shots extracted in the first feature extraction process, and a training process for producing the story segmentation point recognizing device for the specific sections based on the feature obtained from shots within specific sections in the first feature extraction process, and the evaluation process includes a second shot segmentation process for segmenting the input data per shot, a second section extraction process for extracting a section of the input data, a second feature extraction process for extracting the feature of each shot obtained by the second shot segmentation process, an entire story segmentation process for recognizing the entire story segmentation points using the entire feature of each shot obtained in the second feature extraction process and the story segmentation point recognizing device for entire video content, and a specific sections story segmentation process for recognizing the story segmentation points for specific sections using the feature of each shot out of the feature of each shot obtained in the second feature extraction process and the story segmentation point recognizing device for specific sections.

Also, the third feature of this invention is that the story segmentation method for video, wherein the evaluation process provides the story segmentation points of the input data by adding the story segmentation points for specific sections to the story segmentation points for entire video content.

Also, the fourth feature of this invention is that the story segmenting method for video, wherein the evaluation process provides the story segmentation points of the input data by excluding the story segmentation points of the section portions from the story segmentation points for entire video content and inserting the story segmentation points for specific sections.

The present invention produces a story segmentation point recognizing device for entire video content based on training data, and a story segmentation point recognizing device for story segmentation of specific sections in the video content in the training process. Moreover, story segmentation points are provided by integrating the story segmentation result by the story segmentation point recognizing device for entire video content and the recognizing result by the story segmentation point recognizing device for segmentation of specific sections in the video content in an evaluation process. Thereby, the story segmentation points can be extracted accurately and stably also for specific sections having a story configuration different from other parts. For example, for video content having various sections such as a news section, a highly accurate story segmentation can be carried out.

### BRIEF DESCRIPTION OF THE DRAWINGS

FIG. 1 is a flowchart showing an example of a training process in the present invention.

FIG. 2 is an explanatory diagram showing the state of a shot segmentation and a section extraction.

FIG. 3 is a conceptual explanatory diagram for a support vector machine (SVM).

FIG. 4 is a flow chart showing an example of an evaluation process in the present invention.

### DETAILED DESCRIPTION OF THE PREFERRED EMBODIMENT

Hereinafter, the present invention will be explained with reference to the drawings. The present invention on the whole comprises a training process and an evaluation process. In the training process, a story segmentation point recognizing device which conducts story segmentation for entire video content and a story segmentation point recognizing device specialized for story segmentation of specific sections in the video are extracted based on the training data (video data with the story segmentation points clearly shown). And, in the evaluation process, using the story segmentation points recognizing device for entire video content, the story segmentation points are extracted from entire video content, and moreover, using the story segmentation point recognizing device for specific sections, the story segmentation points in specific sections are extracted so that the final story segmentation points are provided by integrating the story segmentation results.

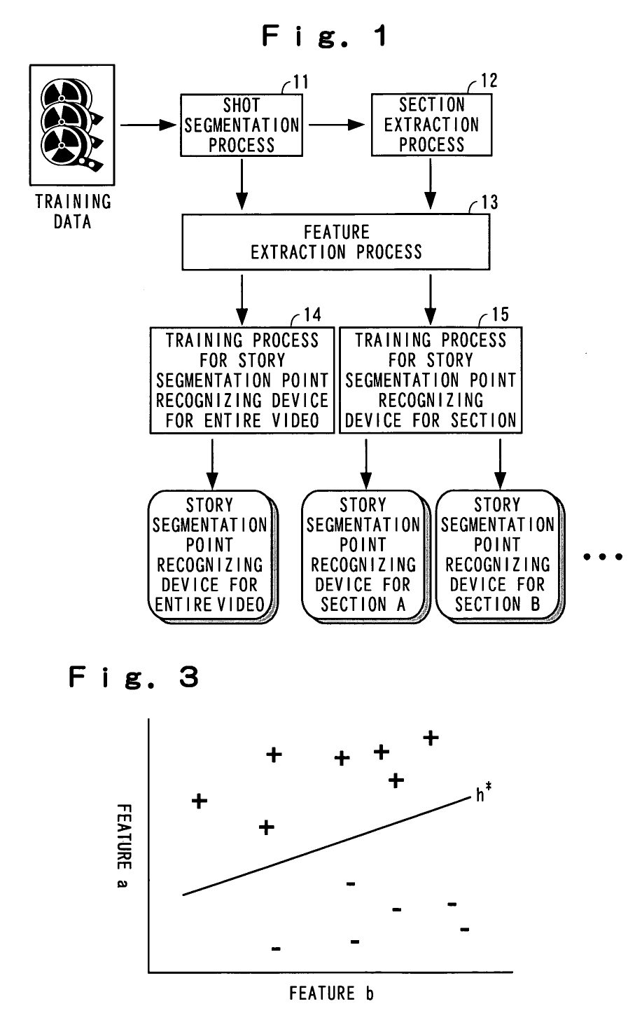

FIG. 1 is a flow chart showing an example of the training process in the present invention. The training process includes a shot segmentation process 11, a section extraction process 12, a feature extraction process 13, a training process 14 for a story segmentation point recognizing device for entire video content, and a training process 15 for story segmentation point recognizing device for specific sections.

To the shot segmentation process 11, video data with specified story segmentation points are inputted as training data. The shot segmentation process 11 is for automatically segmenting the training data per shot unit. For this process, for example, a cut point extracting technique disclosed in the “cut picture group detecting device for video” of Japanese Patent Application Laid Open (JP-A) No. 2000-36966 can be used.

The section extraction process 12 extracts specific sections from the training data. The sections are the portions segmented as sections in video content. For example in the case of a news section, an commentary section, a sports section, an economy section, a special section, a weather section, or the like are present.

In the case of starting and ending points of specific sections are clearly shown preliminarily, as a label or the like, in the training data, the section extraction can be carried out utilizing the starting and ending point information thereof. In the case of starting and ending points of the sections are unclear without clearly shown, specific sections extraction can be carried out also by detecting a jingle picture or an audio signal feature at the time of start or end of specific sections from the video file of the training data. The jingle can be detected by using the active retrieval method disclosed in for example “Kashino, Smith, Murase “Quick audio signal retrieval method based on histogram feature—time sequence active retrieval method—“Shingakuron J82-D-2, Vol. 9, pp 1365-1373, 1999”.

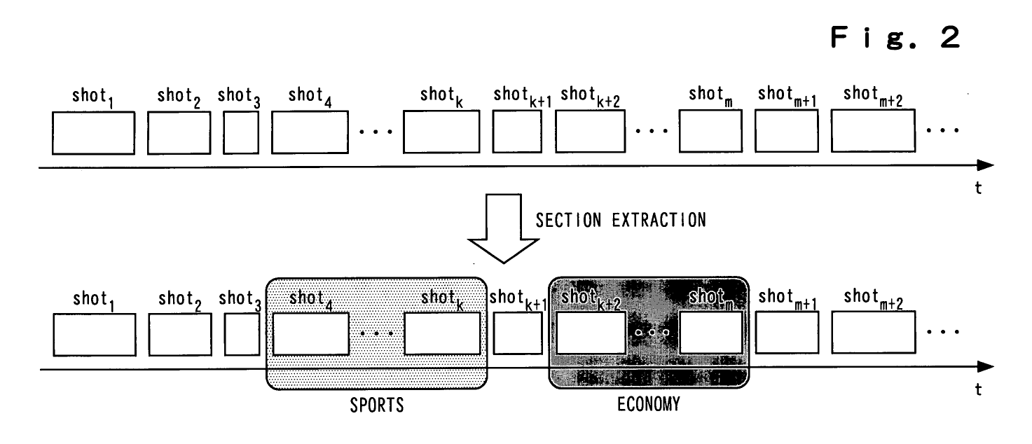

FIG. 2 is an explanatory diagram showing the state of the shot segmentation and the section extraction state. The training data are first segmented per shot unit (shot ₁, shot₂, shot ₃, shot ₄, . . . , shot ₖ, shot ₖ₊₁, shot ₖ₊₂, . . . shot ₘ, shot ₘ₊₁, shot ₘ₊₂, . . . ) in the shot segmentation process 11 (FIG. 1). Next, the section extraction is carried out in the section extraction process 12. FIG. 2 shows the state wherein the sports section shot (SPORTS) (shot ₄, . . . , shot ₖ) is extraction based on the clearly shown starting and ending points or the starting and ending jingle thereof, and the economy section (ECONOMY) shot (shot ₖ₊₃, . . . , shotₘ) is extraction based on the clearly shown starting and ending points or the starting and ending jingle thereof.

The feature extraction process 13 extracts the feature for specific shot segmented by the shot segmentation process 11 and provides the same to the training process for story segmentation point recognizing device for entire video content, and furthermore, it provides the feature of the shot with respect to the section extraction in the section extraction process 12 to the training process 15 for story segmentation point recognizing device for specific sections.

As the feature to be extracted in the feature extraction process 13, color information of picture of each shot (color arrangement of the top frame of the shot, the key frame, the final frame, or the like), picture movement information (degree of the movement at least in one of the vertical direction and the lateral direction), sound volume of the audio data included in each shot (RMS), audio types (voice, vocal, noise, silence, or the like), or the like can be presented. The feature to be extracted here may either be of one type or a plurality of types. In the case of extracting a plurality of kinds of the feature (a, b, c, . . . ), the feature of each shot is handled as a vector (shot ₁ (a, b, c, . . . ), shot ₂ (a, b, c, . . . ), shot ₃ (a, b, c, . . . ), . . . ).

The training process 14 produces a story segmentation point recognizing device for entire video content for recognizing a shot including a story segmentation point and a shot not including a story segmentation point by training based on the feature extracted from the entire shots of the training data or the shots excluding the section portions.

The training process 15 produces story segmentation point recognizing device for specific sections for recognizing the shots including a story segmentation point for the specific sections by training based on the feature extracted from the shots of specific sections extraction in the section extraction process 12. For example, in the case a section A and a section B are extracted from the training data in the section extraction process 12, the training process 15 produces a story segmentation point recognizing device for the section A based on the feature of each shot in the section A and a story segmentation point recognizing device for the section B based on the feature of each shot in the section B.

As the story segmentation point recognizing device for entire video and the story segmentation point recognizing device for specific sections, for example, a support vector machine (SVM) disclosed in “Vapnik: Statistical learning theory, A Wiley-Interscience Publication, 1998”.

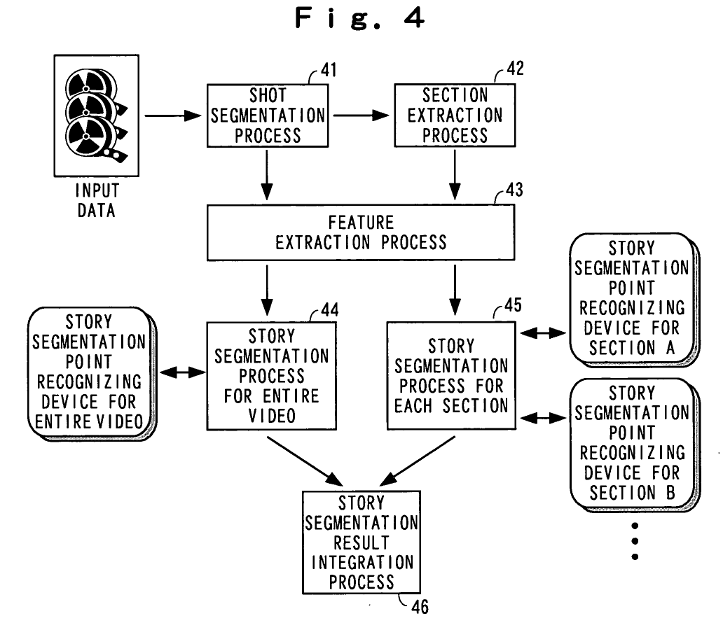

FIG. 3 is a conceptual explanatory diagram for the SVM. The SVM has a separating hyperplane h* to be the threshold value of the automatic classification. The separating hyperplane h* can be obtained by training from the training data. That is, in the case of the training process 14 for story segmentation point recognizing device for entire video content, the feature of the entire shots of the training data or the shots excluding the section portions with the story segmentation points clearly shown is provided to the support vector machine (SVM). And, in the case of the training process 15 for story segmentation point recognizing device for specific sections, the feature of the shots of specific sections of the training data with the story segmentation points clearly shown is provided to the support vector machine (SVM).

Assuming that the features extracted from each shot are for example a, b, as shown in FIG. 3, with the feature a plotted in the vertical axis and the feature b plotted in the horizontal axis, the position of the feature of a shot with the presence of a story segmentation point is plotted with “+” and the position of the feature of a shot without the presence of a story segmentation point is plotted with “−”. Then, the separating hyperplane h* is set such that “+” and “−” can be separated optimally. Thereby, a story segmentation point recognizing device capable of separating a shot with the presence of a story segmentation point and a shot without the presence of a story segmentation point by the separating hyperplane h* based on the features amounts a and b can be established. Although FIG. 3 is the case where there are two kinds of the features, a and b, in the case where there are more than two kinds, plotting is carried out by the dimensional position corresponding thereto such that the separating hyperplane h* is set for optimally separating the same.

FIG. 4 is a flow chart showing an example of the evaluation process in the present invention. The evaluation process includes a shot segmentation process 41, a section extraction process 42, a feature extraction process 43, a story segmentation process 44 for entire video, a story segmentation process 45 for specific sections, and a story segmentation result integration process 46.

In the evaluation process, video with the unknown story segmentation points is inputted as input data. The input data is first segmented in units of shot in the shot segmentation process 41. Next, the sections are extraction in the section extraction process 12. In the feature extraction process 43, the feature is extracted from each shot. The shot segmentation process 41, the section extraction process 42, the feature extraction process 43 are same as the shot segmentation process 11, the section extraction process 12, and the feature extraction process 13 in the training process, respectively.

In the story segmentation process 44 for entire video content, using the story segmentation point recognizing device for the entire video content produced in the training process, the shots including the story segmentation points are extracted from the entire input data. The story segmentation points in the entire input data can be extracted for example based on the relationship between the feature of each shot of the input data and the separating hyperplane h*.

In the story segmentation process 45 for specific sections, using the story segmentation point recognizing device for specific sections produced in the training process, the shots including the story segmentation points are recognized for specific sections of the input data. The story segmentation points for specific sections of the input data can be recognized for example based on the relationship between the feature of each shot of the input data and the separating hyperplane h* of the story segmentation point recognizing device for section corresponding to the section.

In the story segmentation result integration process 46, the story segmentation points of the input data are provided by integrating the story segmentation results for specific sections obtained each in the story segmentation process 44 for entire video content and the story segmentation process 45 for specific sections. For the integration, for example, there are a method of providing the story segmentation points of the input data by adding the story segmentation points obtained in the story segmentation process 45 for specific sections to the story segmentation points obtained in the story segmentation process 44 for entire video content, a method of providing the story segmentation points of the input data by excluding the story segmentation points of the section portions from the story segmentation points obtained in the story segmentation process 44 for entire video and inserting the story segmentation points for specific sections obtained in the story segmentation process 45 for specific sections.

By presenting the story segmentation points recognized as mentioned above to the user, the user can segment and obtain the data portions that the user wants from the input data with reference to the story segmentation points.

The present invention can be used for the story segmentation for video content such as the personal contents. Moreover, it can be used also for video server for providing a specific video based on the story segmentation from video database or executing a service related to video content.

What is claimed is:

1. A story segmentation method for video, comprising:
a training process and an evaluation process, wherein
video data with specified story segmentation points are provided to the training process as training data;
the training process is for producing a story segmentation point recognizing device which conducts story segmentation for entire video content based on the training data, and a story segmentation point recognizing device specialized for story segmentation of specific sections in the video; and
the evaluation process is to extract story segmentation points of input data by extracting story segmentation points from the entire video content in the video by using the story segmentation point recognition device generated based on the entire training data, and by extracting story segmentation point in specific sections in the video by using the section-specialized story segmentation point recognizing device, and integrating the former and latter story segmentation results.

2. The story segmentation method for video according to claim 1, wherein
the training process includes a first shot segmentation process for segmenting the training data per shot, a first section extraction process for extracting a section from the training data, a first feature extraction process for extracting features from each shot obtained by the first shot segmentation process, a training process for producing the story segmentation point recognizing device which conducts story segmentation for the entire video content based on the features of all shots extracted in the first feature extraction process, and a training process for producing the story segmentation point recognizing device for the specific sections based on the feature obtained from shots within specific sections in the first feature extraction process, and
the evaluation process includes a second shot segmentation process for segmenting the input data per shot, a second section extraction process for extracting a section of the input data, a second feature extraction process for extracting the feature of each shot obtained by the second shot segmentation process, an entire story segmentation process for recognizing the entire story segmentation points using the entire feature of each shot obtained in the second feature extraction process and the story segmentation point recognizing device for entire video content, and a specific sections story segmentation process for recognizing the story segmentation points for specific sections using the feature of each shot out of the feature of each shot obtained in the second feature extraction process and the story segmentation point recognizing device for specific sections.

3. The story segmentation method for video according to claim 1, wherein the evaluation process provides the story segmentation points of the input data by adding the story segmentation points for specific sections to the story segmentation points for entire video content.

4. The story segmenting method for video according to claim 1, wherein the evaluation process provides the story segmentation points of the input data by excluding the story segmentation points of the section portions from the story segmentation points for entire video content and inserting the story segmentation points for specific sections.
